(19) United States
(12) Patent Application Publication
(10) Pub. No.: US 2002/0012249 A1
(43) Pub. Date: Jan. 31, 2002

(54) Headlamp for motor vehicles

(76) Inventors: Reinhold Brummel, Anroechte (DE); Detlef Korff, Lippstadt (DE); Matthias Knoche, Bad Westernkotten (DE); Joerg Plotzitzka, Lippstadt (DE); Thomas Boernchen, Bamberg (DE)

Correspondence Address: BIRCH STEWART KOLASCH & BIRCH, PO BOX 747, FALLS CHURCH, VA, 22040-0747, US

(21) Appl. No.: 09/840,460

(22) Filed: Apr. 24, 2001

(30) Foreign Application Priority Data
Apr. 28, 2000 (DE) 100 21 040.6

(51) Int. Cl. B60Q 1/00

(52) U.S. Cl. 362/459

(57) ABSTRACT

The invention concerns a headlamp for vehicles having a reflector, a light source arranged in a central zone of the reflector and an adjustment apparatus to adjust the reflector about a vertical pivot axis relative to a holding part into a predetermined curve-illumination operational position; with the reflector being in engagement with a shaft of the adjusting apparatus which is oriented parallel to the vertical pivot axis via a curved element rigidly coupled to the reflector and extending perpendicular to the vertical pivot axis, and with the reflector being mounted to be rotatable relative to the holding part by a coupling having a pretensioned centering spring element.

This invention concerns a headlamp for a vehicle having holding part and a pivotal part pivotal about a vertical axis relative to the holding part, there being a light element in a central zone.

German Patent Publication DE 197 21 095 A1 discloses a headlamp for a vehicle, which is coupled to a horizontally driving worm via a vertically extending turn shaft and a worm wheel fixedly attached to the turn shaft. The worm is coupled to a motor, which is controlled by a control unit in such a manner that the headlamp experiences a desired horizontal alignment to achieve a curve illumination. It is disadvantageous in this known headlamp that the adjustment apparatus formed of the turn shaft, the worm wheel, the worm and the motor requires a relatively large amount of space. Because the entire headlamp must be pivoted, a relatively large amount of force is necessary. Further, it is disadvantageous that if the electronic control fails the headlamp stays fixed in its last assumed operational position.

Further, a headlamp for vehicles is disclosed in German patent document DE 198 02 023 A1, which can be provided with an adjustment apparatus which has a linear adjustment element coupled to a reflector of the headlamp by a ball joint so that a pivoting thereof about a vertical axis to achieve curve illumination is made possible. Indeed, by coupling the adjustment element only to the reflector, there is a decreased force requirement for pivoting. At the same time, tolerance errors can be caused by coupling the linear adjustment element with the reflector with a ball joint, which disadvantageously affects the exactness of predetermined pivot adjustments of the reflector. Also, a disadvantage of this known headlamp is that if the electronic control should fail, the reflector becomes fixed in its last assumed operational position.

It is an object of this invention to provide a headlamp for vehicles having a basic light function as well as additional light functions, for example curve light, city light etc., such that when there is a small mounting space a reliable adjustment of the illumination function is assured.

According to principles of this invention, a headlamp of the type set forth in the preamble of patent claim 1 is characterized by having an adjusting apparatus with an adjusting element attached to the holding part that operates on a coupling element of a pivotal part to adjust the pivotal part about a pivot axis, with a centering spring device being is provided so that the pivotal part is automatically returned to a predetermined position in a non-operational condition.

A particular benefit of this headlamp is that the adjusting apparatus as well as the centering spring device make possible a dependable and long-term stable adjustment to a predetermined curve-illumination operational position. In particular, the centering spring device causes the pivotal part to always return to a predetermined position, in particular to a zero position, in the case of disturbance or a current-less condition of the adjusting apparatus.

According to a preferred embodiment of the invention, the adjusting apparatus is structured as an electronic adjustment apparatus which is allocated to a holding part and which has an adjusting element that when operational is in engagement with a coupling element of the pivotal part. It is beneficial that each of the adjusting element and the coupling element has toothing so that a predetermined pivot angle can be positively and dependably set.

According to a particular beneficial embodiment of the invention, the adjusting apparatus has an electric drive motor that is coupled to the adjusting element by an electromagnetic coupling. In a non-operational condition, the coupling is released with the adjusting element being pivoted out of an engagement position, into a non-engagement position, with the coupling element. The coupling element is now free from the adjusting-element applied forces so that, in cooperation with the centering spring device, the coupling element and the pivotal part that is rigidly connected therewith are moved to the zero position. Thus, a certain and dependable zero-point positioning of the pivotal part can be beneficially achieved.

According to a further enhancement of the invention, the centering spring device is of two centering spring elements, which extend from opposite ends thereof substantially perpendicular to the pivot axis, between the holding part and the pivotal part. Because the centering spring device is mounted under pre-tension, the spring characteristic curve can be selected to be relatively flat so that upon an outward pivoting, or return pivoting, of the pivotal part a small return force change is developed. In a predetermined angle zone of for example +/−15° in a small bandwidth differential, a relatively high return force can be brought about.

A benefit of a further preferred embodiment of the headlamp is that the structure of a curved element rigidly connected with the reflector achieves a direct coupling with the adjusting apparatus, wherein the curved element can be directly coupled with a drive shaft of an electric motor of the adjusting apparatus. Because the reflector cooperates on the one hand directly with the drive shaft of the adjusting apparatus via the curved element and on the other hand rotationally with the holding element via the pre-tensioned centering spring element, a play-free adjustment of the reflector is made possible, with the high stiffness and relatively small number of movable parts of the headlamp favorably affecting lifetime stability. The pre-tensioned centering spring element has a double function. For one thing, it supports the adjustable mounting of the reflector relative to the holding part. For another thing, it makes possible the automatic pivoting of the reflector to a central default position in case of failure of an electrical supply to the adjustment apparatus.

According to a particular embodiment of the invention, the curved element extends sector-or fan-shaped from a central area in a light-exiting direction of the headlamp. Thereby, a curved edge of an end facing away from the pivot axis forms a toothing that has a constant radius to the pivot axis. The curved element is structured in the manner of a toothed-wheel segment and preferably extends into a lower front space of the headlamp so that the already-available and normally-not-used mounting space of the headlamp is filled out. Because of the relatively large spacing of the curved edge from the pivot axis, a relatively high gear reduction can be developed

According to a further enhancement of the invention, the centering spring element is structured as a leaf spring extending perpendicular to the pivot axis and extending between two vertically extending abutment lugs of the holding part. The leaf spring has a diminishing progression of the return moment relative to the deflection angle. The progression of the rotation moment is, up to a deflection angle of 20-30°, relatively steep so that simply a defined curve illumination operational position can be set. Further, upon a failure or a turning-off of the drive unit, a dependable return of the reflector to a central middle position is thereby assured.

According to a further enhancement of the invention, the drive unit has a step motor with a shaft, which engages directly with the toothing of the curved wheel of the curved element. It is beneficial in this regard that an uncomplicated control to intermediate positions of the curve-illumination function is produced. Abutment stops for the end positions of the curved element are not necessary.

According to a further enhancement of the invention, the light source is held on a light support part, which can be pivoted relative to the holding part about a horizontal axis. This horizontal axis is arranged orthogonal to the vertical pivot axis and forms together therewith a vertical plane. Thus, a cardanic mounting of the light support part is formed, so that a space-saving plurality of different light functions can be carried out by pivoting about two axes extending in a common plane.

According to a further enhancement of the invention, the light support part is coupled by a coupling element with an axially movable positioning pin of a second adjusting apparatus in such a manner that in two operational positions respective ends of the coupling element forms a vertical plane with the vertical pivot axis. In this manner, a decoupling of the curve-illumination-adjustment function on the one hand from two further light-function adjustments (low beam/high beam) on the other hand is achieved.

Preferably, by providing a pre-tensioned spring on the one hand, that is coupled to the light support part and a pivotal coupling of the coupling element with the positioning pin on the other hand, it is assured that the light support part is always in a predetermined end-position to produce a high beam or a low beam light function. Because the ends of the coupling element in the respective operational positions always find themselves in a plane with the vertical pivot axis, a holding force developed by the pre-tensioned spring is, independently of the adjustment of the curve light illumination, constant. By the pivotal mounting of the end of the coupling element facing the positioning pin, the adjustment angle remains constant during a curve-illumination function adjustment so that a set curve-illumination operational position is not changed during adjustment from the low beam to the high beam function or vise versa.

To positively engage the low-beam-and-high-beam function, the reflector support part and/or the light support part has abutment stops so that in the respective operational positions the support parts lie directly against one another. Thus, in connection with this linear operating adjustment apparatus a simple end-position operational adjustment can be achieved.

Embodiments of the invention are described below with reference to the drawings:

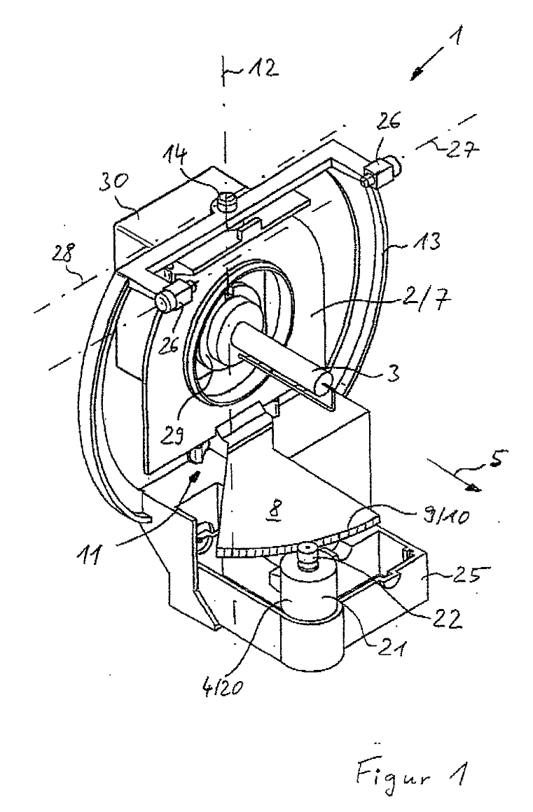

FIG. 1 is a perspective front view of a headlamp;

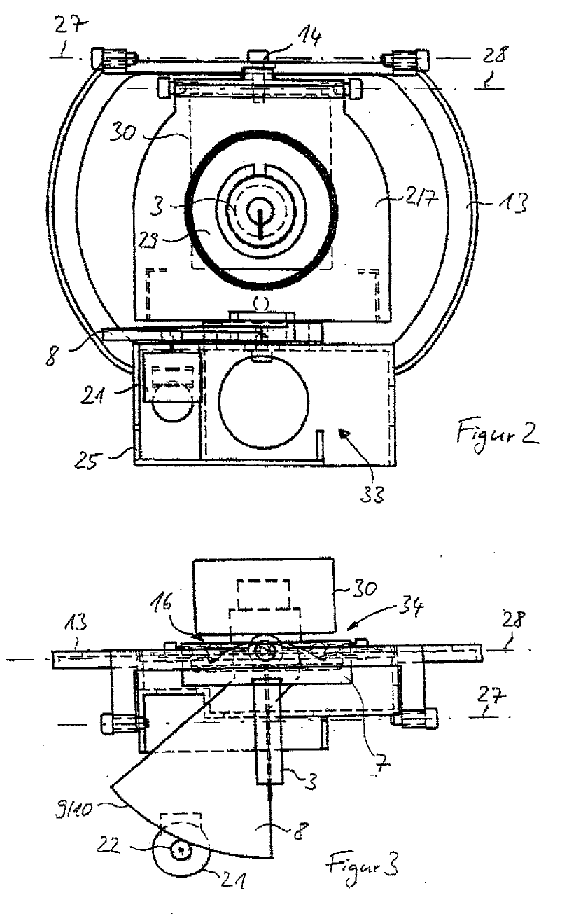

FIG. 2 is a schematic front view of the headlamp;

FIG. 3 is a schematic plan view of the headlamp;

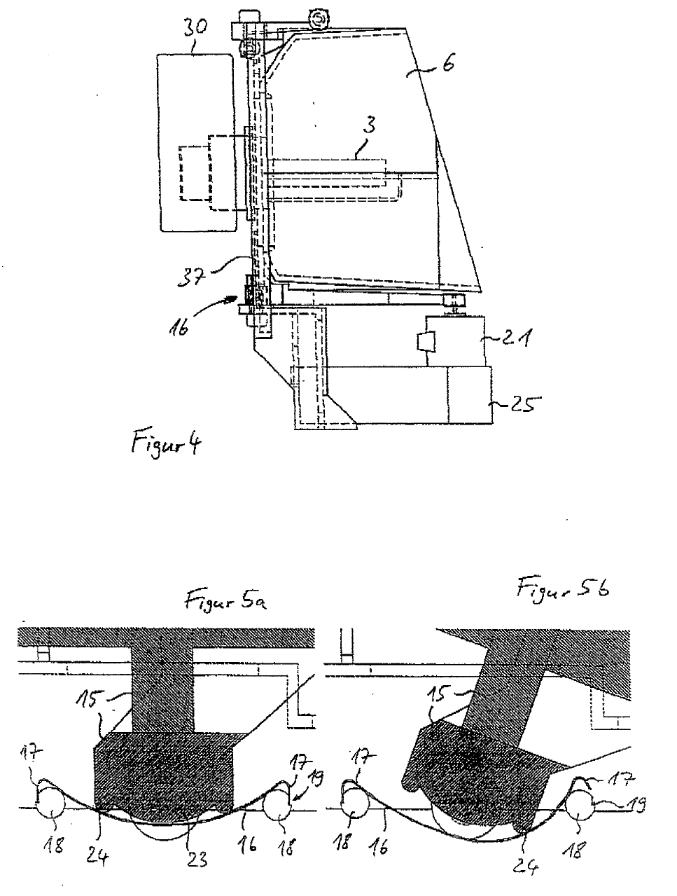

FIG. 4 is a side view of the headlamp;

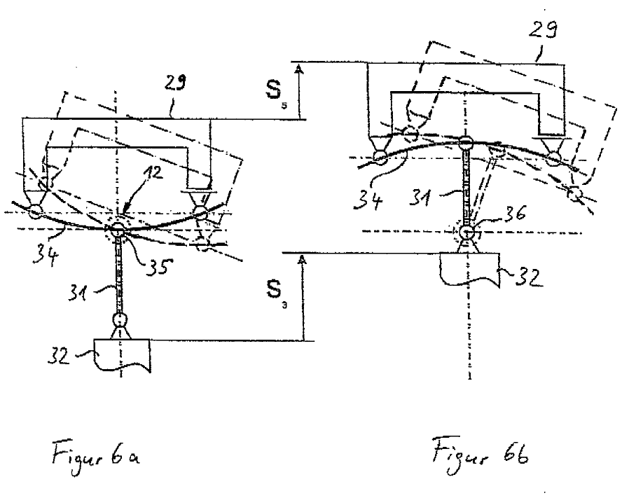

FIG. 5a is a schematic plan view of a coupling of a reflector support part to a holding part of the headlamp by a centering spring element in a central middle position of the reflector support part;

FIG. 5b is a schematic plan view of the coupling of the reflector support part to the holding part of the headlamp by the centering spring element in a 20-degree to the right pivoted position of the reflector support part;

FIG. 6a is a schematic representation of a coupling of a positioning pin to a pre-tensioned spring element of a light support part of the headlamp in a retracted (low-beam function);

FIG. 6b is a schematic representation of the coupling of the position pin to the pre-tensioned spring element of the light support part of the headlamp in a pushed-out position (high-beam function);

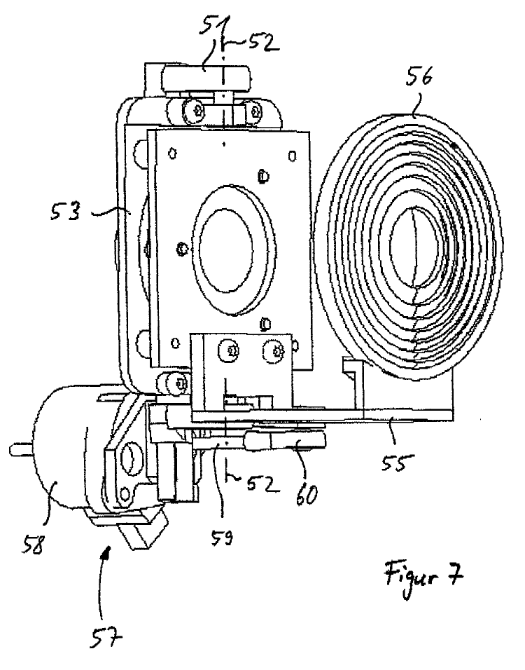

FIG. 7 is a perspective representation of a headlamp according to a second embodiment;

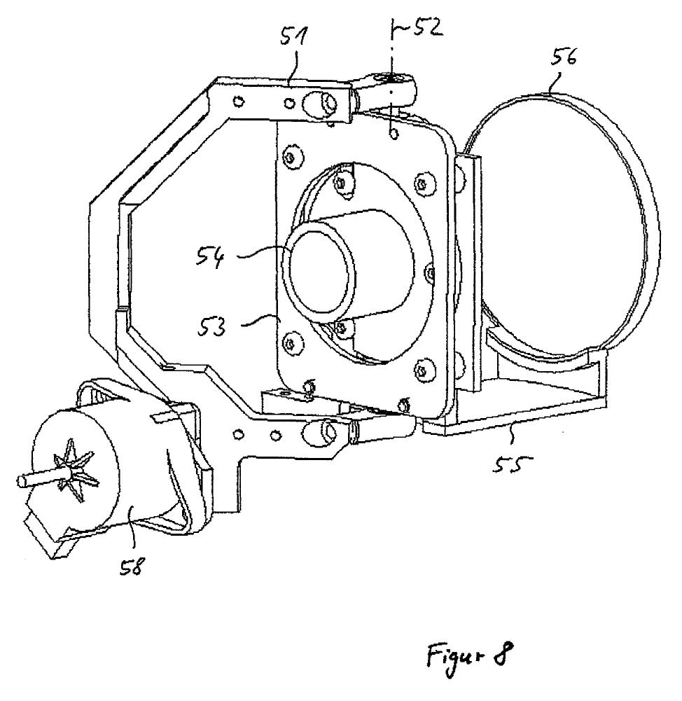

FIG. 8 is a perspective representation of a headlamp according to the second embodiment as seen from a back side;

FIG. 9 is a plan view of a headlamp according to the second embodiment;

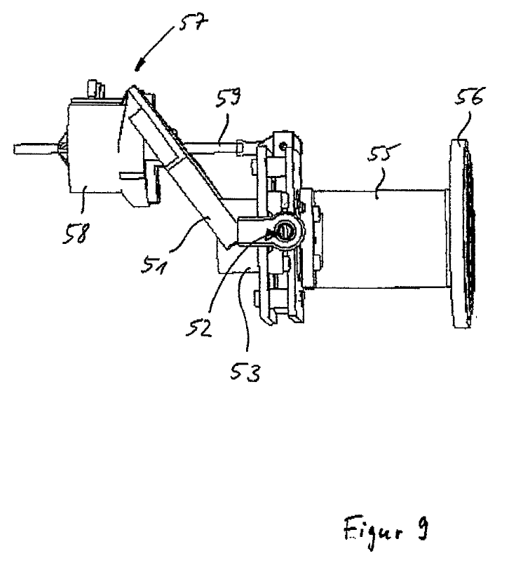

FIG. 10 is a schematic representation of the coupling of a holding part and a pivotal part of the headlamp according to a further embodiment;

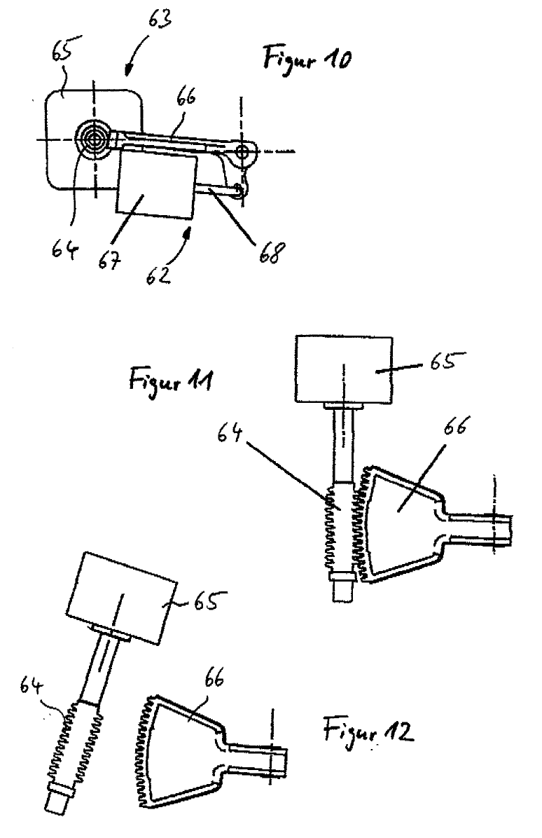

FIG. 11 is a plan view of a coupling element of the headlamp in engagement with an adjusting element of an adjusting apparatus that is rigidly coupled to the holding part;

FIG. 12 is a schematic representation of the adjusting element and the coupling element in a non-engaged position;

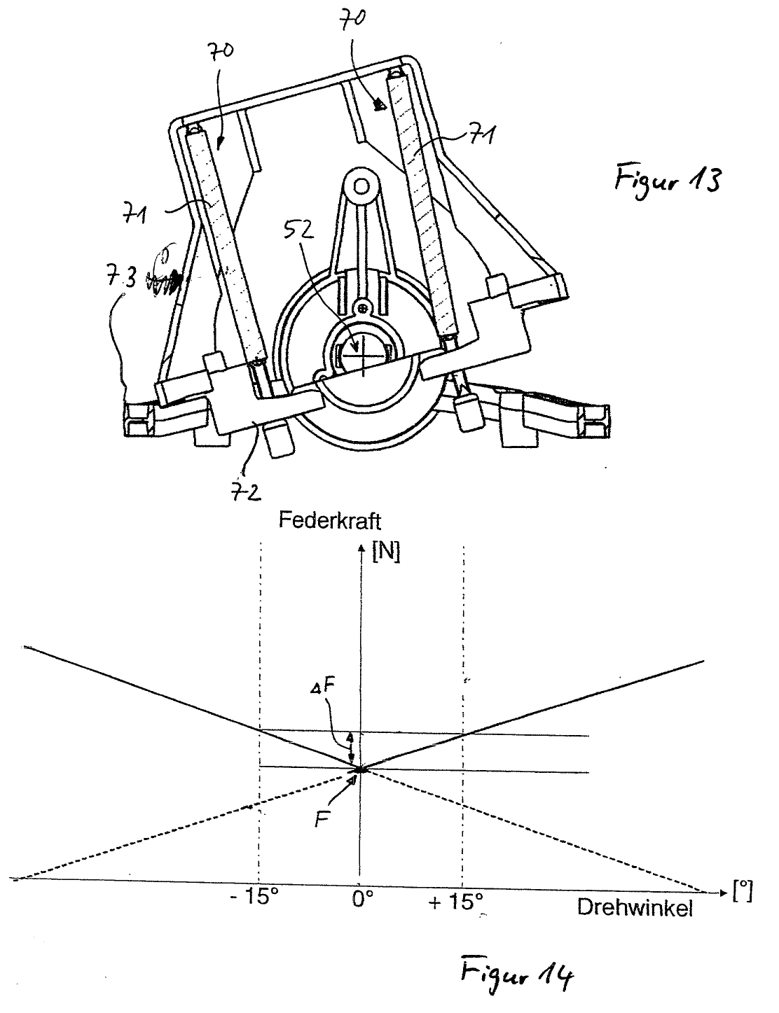

FIG. 13 is plan view of a centering spring device which is coupled with a holding part and a pivotal part of a headlamp; and

FIG. 14 is a spring characteristic curve of the centering spring device.

FIG. 1 shows a headlamp 1 for a vehicle, which basically including a reflector 2, a light source 3 and an adjusting apparatus 4.

The reflector has a reflector element 6 held on a pivotal part or reflector support part 7 whose reflecting interior surface is oriented in a beam direction 5. The reflector support part 7 has a frame-like structure and has an opening for accommodating the light source 3 at a central zone thereof. A curved element 8 is rigidly attached to a side of the reflector support part 7 facing a cover pane (not shown) of the headlamp 1 that has a fan-like shape and has a rounded curved edge 9 with toothing 10, which extends away from a central zone 11 in which the reflector support part 7 is arranged.

The curved edge 9 extends with a constant radius about a vertical pivot axis 12, about which the reflector support part 7 is mounted to pivot relative to a frame-like holding part 13. For this purpose, the reflector support part 7 is movably coupled with the holding part 13 in an upper space by a joint 14. In a lower space the reflector support part 7 has a reflector projection 15 that is rotationally mounted to the holding part 13 by a pre-tensioned centering spring element 16.

The centering spring element 16 is formed as a leaf spring extending perpendicular to the pivot axis 12, with ends 17 thereof bent about support lugs 18 of the holding part 13. As can be better seen in FIG. 5a, the ends 17 lie directly on abutment stops 19 of the support lugs 18 in a central starting position of the reflector support part 7 and the reflector projection 15.

For creating a curve-light function, the reflector is pivoted about the pivot axis 12 by the adjusting apparatus 4 to a desired operational position. For this purpose, a drive unit 20 of the adjusting apparatus 4 is in direct engagement with the curved edge 9 of the curved element 8.

The drive unit 20 has an upright-standing step motor 21 with a drive shaft 22 that is oriented parallel to the pivot axis 12. The drive shaft 22 engages the toothing 10 of the curved edge 9.

By controlling the drive unit 20, the curved element 8 is turned about the pivot axis 12 to a desired position, whereby simultaneously a pivoting of the reflector projection 15 occurs (see FIG. 5b). The reflector projection 15 has a central rounded portion 23 with a large radius between adjacent outer rounded portions 24, each with a smaller radius. The central rounded portion 23 is oriented substantially coaxial to the pivot axis 12. A rear contour of the reflector projection 15 assures that the reflector support part 7 is always safely held by pressure between the drive shaft 22 of the step motor 21 and the leaf spring 16 of the holding part 13.

The drive unit 20 is fixedly located in a housing 25 of the adjusting apparatus 4 that is rigidly attached to the holding part 13. The holding part 13 is mounted to be pivotal at a joint 26 about the horizontal axis 27 relative to a housing (not shown) of the headlamp 1 so that vertical inclination of the headlamp 1 can be adjusted by a distance-illumination adjustment device (not shown) arranged on a backside of the holding part 13.

The horizontal axis 27 is positioned behind a further horizontal axis 28 about which a light support part 29 is mounted for rotation relative to the reflector support part 7. The light support part 29 supports the light source 3, which is structured as a gas discharge lamp and is attached on a backside of the discharge lamp 3, along with an ignition module 30. The light support part 29 is coupled to an axially movable positioning pin 32 of a second adjusting apparatus 33 by a coupling element 31. The second adjusting apparatus 33 has an electric motor (not shown), which is coupled with the positioning pin 32 by a transmission. The thusly-structured second adjusting apparatus 33 can be mounted in the common housing 25 with the first adjusting apparatus 4.

By manipulating the second adjusting apparatus 33 the light support part 29 is pivoted between two end positions, wherein in a first operational position according to FIG. 6a the headlamp assumes a low beam function, and in a second operational position according to FIG. 6b the headlamp assumes a high beam function. As can be seen from the low beam position according to FIG. 4, the light source 3 in the high beam operational position is arranged to be inclined downwardly about the horizontal axis 28. The light support part 29 is coupled with the coupling element 31 by a pre-tensioned spring element 34, with the spring element 34 being formed to be lamellar, and extending to be substantially bowed in the horizontal direction. In this regard, the spring element 34 is held in a receiver (not shown) of the coupling element 31 and touches it along a vertical line.

As can be seen in FIG. 6a, the positioning pin 32 is in the low-beam operational position when it is in a retracted position with an end 35 of the coupling element 31 directed toward the spring element 34 extending in a common vertical plane with the vertical pivot axis 12. In this manner, a bending of the spring element 34 is independent of the curve-light-function setting of the reflector 2. Upon pivoting the reflector support part 7 about the vertical pivot axis 12, the end 35 always remains in the same position.

Also, in the high-beam operational mode, according to FIG. 6b, the headlamp 1 can assume a desired curve-light operational position without influencing the set high-beam operational position. In this regard, in the high-beam operational mode the positioning pin 32 is moved to such an outwardly driven position that an end 36 of the coupling element 31 directed toward the positioning pin 32 forms a common vertical plane with the vertical pivot axis 12. To limit the retracted and outwardly-driven positions of the light support part 29, abutment stops 37 are provided that come in contact with abutment stops of the reflector support part 7 in the respective operational positions.

Thus, the continually adjusted curve-light positions, on the one hand, and the low beam and high beam settings on the other hand are completely decoupled from one another. As can be seen in FIGS. 6a and b, the end 35 intersects the vertical pivot axis 12 in the low-beam position and the end 36 intersects the vertical pivot axis 12 in the high-beam position. The end 36 is coupled with the positioning pin 32 by a ball joint. Because the bend of the spring element 34 at the respective end positions is oriented differently, the adjustment path S3 of the positioning pin 32 is larger than the adjustment path S5 of the light support part 29 by an amount double the bowing of the spring element 34. Upon the reflector support part being rotated about the pivot axis 12, the coupling element 31 can follow the circular path of the spring element 34 about the pivot axis 12 in the manner of a pendulum support and thereby hold the bend constant. By providing a balljoint connection at the end 36 to the positioning pin 32, a tensionfree spatial movement of the light support part 29 is made possible.

The light support part 29 is Cardanically arranged in the holding part 7.

Alternatively, the headlamp 1 can also be structured according to a projection principle with the reflector support part being additionally coupled with a light shield (not shown) and a lens. The low beam/high beam function in this case is made possible by a second movable light shield. The light shield, in this case, includes a fixed shielding part and a movable shielding part, with the movable part preferably being structured to be pivotal about to the fixed shielding part between two end positions so that one can switch between the two light functions by manipulating the movable shielding part.

According to an alternative embodiment according to FIGS. 7 through 9, a headlamp is provided with a frame-like holding part 51 that is rigidly attached to a housing (not shown) of the headlamp. A pivotal part 53 is pivotally mounted on the holding part 51 to the pivotal about a pivot axis 52. The pivotal part 53 has a cylindrically-shaped light-guide receiver 54 into which a light guide (not shown) can be extended from the rear. An end of the light guide directed away from the headlamp is preferably coupled with a light source and serves as a transmitting path for coupled light to the headlamp. Preferably, the light guide has a light-outcoupling element at an end directed in the light projection direction with a predetermined form that serves to create a symmetrical or asymmetrical light distribution. A spacer 55 in front of the holding part 51, which is rigidly connected to the pivotal part 53, aligns an optical element 56 to be coaxial to the light guide receiver 54 as well as the light-outcoupling element of the light guide.

So that the pivotal part 53, along with the spacer 55 and the optical element 56, can be pivoted about the pivot axis 52 relative to the holding part 51 for creating a curve illumination, an adjusting apparatus 57 is provided which generally comprises an electrical adjusting motor 58 and a plunger 59 as an adjusting element. The optical element 56 can be formed as a Fresnel lens, a free-surface lens, or a rotationally symmetrical convex-formed light-outcoupling element. Preferably, the light guide extends sufficiently far into the light-guide receiver from the backside that the light guide comes into direct contact with the optic element 56. The plunger 59 is linked to a pivot arm 60 of the pivotal part 53 at a spacing from the pivot axis 52. The pivot arm 60 serves as coupling element and is rigidly coupled with the pivotal part 53. Operation of the adjusting motor 58 drives the plunger 59 in and out so that a corresponding pivoting of the pivotal part 53 takes place.

According to a further embodiment of the headlamp according to FIG. 10 and FIG. 11, contrary to the embodiments previously described, an adjusting apparatus 63 can be provided that instead of having a plunger has a worm 64 which can be rotated by an electric adjusting motor 65. In the operational position of FIG. 11, the worm 64 is in engagement with a coupling element 66, which is formed as a toothed segment. The toothed segment 66 is rigidly connected to the pivotal part 53.

Additionally, a separating device 62 is provided for moving the worm 64 and the toothed segment away from each other with the separating device having an electric activation magnet (electromagnet) 67 and a plunger rod 68. The electromagnet 67 is coupled with the toothed segment 66 by the plunger rod 68 so that in a non-operational condition, in which the electromagnet 67 is not energized by a current, a spring (not shown) coupled with the plunger rod 68 holds the plunger rod 68 in a return position in which the toothed segment 66 not engaged with the worm 64. In an operational condition an electric current is applied to the electromagnet 67, and the electromagnet 67 holds the plunger rod 68, against the spring force, in a position in which the toothed segment 66 is in engagement with the worm 64.

If the headlamp is in a non-operational condition, for example because of a defect in wiring or because of a controlled switching off, the electromagnet is also without current so that the plunger rod 68 moves in and thereby moves the toothed segment 66 about a rotational axis 69 that extends perpendicular to the pivot axis 52 into a non-engaging position with the worm 64. The toothed segment 66, and therefore the pivotal part 53, is now force-free from the adjusting apparatus 63 and the toothed segment can therefore be transported under its own means into a centered, zeroed, position. Alternatively, the toothed segment 66 can be brought to a desired predetermined angular position.

Alternatively, also, the worm 64 can be brought into a non-engaging position. To achieve this, the electromagnet 67 coupled to the holding part 51 must be pivoted by an appropriate means opposite to the direction toward the toothed segment 66.

According to a preferred embodiment, the separating device 62 has an electric adjusting motor rather than an electromagnet 67, with the electric motor being coupled to the plunger rod 68 by an electromagnetic coupling. In dependence of the above on a current supply, a corresponding switch setup can be appropriately established. Alternatively, a friction clutch can be used.

To bias the headlamp of FIGS. 7-12 a centering spring device 70 according to FIG. 13 can be provided. The centering spring device 70 is of two identical centering spring elements 71 that are arranged to be substantially perpendicular to the pivot axis 52 and on oppositely positioned sides of the same. Ends of the centering spring elements 71 are respectively coupled, on the one hand, to a pivotal part 72 that, for example, can support a reflector, and, on the other hand, to a holding part 73. As can be seen in FIG. 14, the centering spring elements 71 are pre-tensioned a predetermined spring force F. In this manner, the spring characteristic curve can be made to be relatively flat so that in a rotational angle zone from +/−15 degrees, only a spring force difference ΔF appears. Because of this, a relatively even return force can be created in the different pivot angle positions for the curve illumination. Because both centering spring elements 51 are pre-tensioned, only one centering spring element 71 is effective upon a deflection of the pivotal part 53, while the other centering spring element 51 operates against the return force with a smaller, amount-wise, spring force, see the dashed characteristic line in FIG. 14. Upon each deflection of the pivotal part 53 around the zero position, a combined return force results which corresponds to the difference for the corresponding turn angle between bold characteristic line and the dashed characteristic line.

The centering spring elements 71 are arranged at the same spacing from the pivot axis 52 and each has a length that is greater than double the spacing of each centering spring element 71 from the pivot axis 52. The centering spring elements can be structured as extension, compression or lever springs.

What is claimed is:

1. Headlamp for vehicles having a holding part and a pivotal part that is pivotal thereto about a vertical axis and having a light element in a central zone, characterized in that a positioning element (59, 64) of an adjusting apparatus (57, 63) is associated with the holding part (51), a coupling element (60, 66) of the pivotal part (53) is operated on to adjust the coupling element about the pivot axis (52) and a centering spring device (70) is provided in such a manner that in a non-operational condition the pivotal part (53) is automatically returnable to a predetermined position.

2. The headlamp of claim 1 characterized in that the centering spring device (70) has at least two centering spring elements (71) that are substantially perpendicular to the pivot axis (52) and extend at their opposite ends between the holding part (51) and the pivotal part (53) whereby the centering spring elements (71) are mounted with a predetermined tension so that the pivotal part (53) is always moved to the predetermined zeroed position in a non-operational condition.

3. The headlamp of claims 1 or 2 characterized in that the centering spring elements (71) have a predetermined tension of the same amount and in the same direction.

4. The headlamp of any one of claims 1 through 3 characterized in that the centering spring elements (71) are arranged to have the same spacing from the pivot axis (52).

5. The headlamp of any one of claims 1 through 4 characterized in that each of the centering spring elements (71) has a length, which is greater than double the spacing of each centering spring element (71) from the pivot axis (52).

6. The headlamp of any one of claims 1 through 5 characterized in that the centering spring elements are each formed as one of a compression spring, extension spring, joint spring and leaf spring.

7. The headlamp of any one of claims 1 through 6 characterized in that the adjustment element (59) of the adjustment apparatus (57) is oriented perpendicular to the pivot axis (52).

8. The headlamp of any one of claims 1 through 7 characterized in that the adjusting apparatus (57, 63) includes an electric motor (58) for moving the positioning element (59) perpendicular to the pivot axis (52) at a spacing from the pivot axis (52).

9. The headlamp according to any one of claims 1 through 8 characterized in that the positioning element (64) and the coupling element (66) respectively have toothings, with which they are engaged at least when in an operational condition.

10. The headlamp according to any one of claims 1 through 9 characterized in that the coupling element is formed as a fan-shaped toothed segment (66) having toothing on an outer perimeter thereof.

11. The headlamp according to any one of claims 1 through 10 characterized in that the adjusting apparatus (63) includes means for moving the positioning element (64) and the coupling element (66) out of engagement in a non-operational condition.

12. The headlamp according to any one of claims 1 through 11 characterized in that a separating device (62) operates on the positioning element (64) and/or the coupling element (66) such that in a non-energized, non-operational condition the positioning element (64) and/or the coupling element (66) are moved away from each other.

13. The headlamp according to any one of claims 1 through 12 characterized in that the separating device (62) includes an electromagnet (67) that operates on the pivotal part (53) with a plunger rod (68).

14. The headlamp according to any one of claims 1 through 12 characterized in that the separating device (62) includes an electric motor that is coupled to a plunger rod (68) via an electromagnetic coupling, with the plunger rod operating on the pivotal part (53).

15. The headlamp according to claim 1 characterized in that the pivotal part includes a reflector (2) that is rigidly coupled to a curved element (8) extending perpendicular to the vertical pivot axis (12) that is in engagement with a shaft (22) of the adjusting apparatus (4) that is parallel to the vertical pivot axis (12), the reflector (2) being mounted to be rotatable relative to the holding part and being coupled to a pre-tensioned centering spring element (16).

16. The headlamp according to claim 15 characterized in that the curved element (8) extends from a space near the vertical pivot axis (12) substantially in a beam direction, to form a fan shape, with a curved edge (9) thereof spaced from the vertical pivot axis (12) having toothing (10).

17. The headlamp according to claims 15 or 16 characterized in that the centering spring element (16) is formed as a leaf spring extending perpendicular to the vertical pivot axis (12) whose ends (17) come in contact with two parallel-to-the-vertical-pivot-axis (12) support lugs (18) of the holding part (13) on the one hand, and whose central portion comes into contact with a reflector projection (15) of the reflector (2) on the other hand.

18. The headlamp according to any one of claims 15 through 17 characterized in that the adjusting apparatus (4) has a drive unit (20) with a step motor (21), whose drive shaft (22) is in engagement with the curved edge (9) of the curved element (9).

19. The headlamp according to any one of claims 15 through 18 characterized in that the light source (3) is held in a light support part (29) that is arranged to pivot about a horizontal axis (28) relative to the holding part (13) to carry out at least two light functions with the horizontal axis (28) intersecting the vertical pivot axis (12), and in that the reflector (2) has a substantially parabolic shape.

20. The headlamp according to any one of claims 15 through 19 characterized in that the light support part (29) is coupled with an axially movable positioning pin (32) of a further adjusting apparatus (33) by a coupling element (31) in such a manner that in a retracted position of the positioning pin (32) an end (35) of the coupling element (31) facing away from the positioning pin (32), and in a driven-out position of the positioning pin (32) an end (36) of the coupling element (31) directed toward the positioning pin (32) are arranged at the vertical pivot axis (12).

21. The headlamp according to any one of claims 15 through 20 characterized in that the end (36) directed toward the positioning pin (32) is movably linked with the positioning pin (32).

22. The headlamp according to any one of claims 15 through 21 characterized in that the end (35) of the coupling element (31) facing away from the positioning pin (32) has a bracket form and is coupled with a pre-tensioned spring element (34) of the light support part (29) extending parallel to the horizontal axis (28) at a vertical contact line.

23. The headlamp according to any one of claims 15 through 22 characterized in that the holding part (13) has a frame-like structure, surrounding the light support part (29) and a reflector support part (7) of the reflector (2).

24. The headlamp according to any one of claims 15 through 23 characterized in that the reflector support part (7) and/or light port part (29) have abutment stops (37) so that the reflector port part (7) and the light support part (29) are directly against one another in the respective light function operational positions.

25. The headlamp according to any one of claims 15 through 18 characterized in that the reflector support part (7) is fixedly attached with a light shield and a lens, with the reflector having an ellipsoid shape.

26. The headlamp according to claim 25 characterized in that light shield has a fixed shield part and a movable shield part.
